(19) United States
(12) Patent Application Publication
(10) Pub. No.: US 2005/0036298 A1
(43) Pub. Date: Feb. 17, 2005

(54) Soft plastic iridescent illuminations

(76) Inventor: Yihong Yao, Dongguan City (CN)

Correspondence Address: NIXON & VANDERHYE, PC, 1100 N GLEBE ROAD, 8TH FLOOR, ARLINGTON, VA, 22201-4714, US

(21) Appl. No.: 10/637,651

(22) Filed: Aug. 11, 2003

(30) Foreign Application Priority Data
Jun. 11, 2003 (CN) 03247135.1

(51) Int. Cl. F21V 9/16

(52) U.S. Cl. 362/84

(57) ABSTRACT

A kind of soft plastic iridescent illumination includes miniature bulbs in axial array and wrapped by a transparent material, and a core line outside the connecting wire made of soft plastic polymer. A color layer is provided outside the core line. The adoption of this structure will provide advantages of simple structure, aesthetic appearance, excellent decorative effect, rich and brilliant colors, wide range of applications, etc.

### CROSS-REFERENCE TO RELATED APPLICATION

This application is related to and claims priority to Chinese Application No. 03247135.1, filed Jun. 11, 2003, incorporated herein by reference in its entirety.

### BACKGROUND OF THE INVENTION

1. Field of the Invention

The present utility model relates to a decorative lighting device, especially a kind of soft plastic iridescent illumination.

2. Background of Related Technology

At present, there is a great variety of lamps available in the market. Some iridescent illuminations are wire-shaped, which includes a number of bulbs that are connected together. Another form is to cover the bulb with transparent plastic sleeve. It also has effects of iridescent illuminations, but because the sleeve fits over the bulb, it looks like dot-shaped particle light source, which cannot become an uninterrupted lighting. Especially when it is mounted high in the sky or at a great distance, the brightness is insufficient, which brings about dull and unattractive feelings without decoration effects.

### DESCRIPTION OF THE INVENTION

One aspect of the present invention is to provide a kind of soft plastic iridescent illumination possessing advantages of simple structure, aesthetic appearance, excellent decorative effects, and rich and brilliant colors.

According to one embodiment, a soft plastic iridescent illumination includes miniature bulbs that are in axial array and wrapped by a transparent material, and a core line outside a connecting wire, made of soft plastic polymer, wherein a color layer is provided outside the core line.

In another embodiment, a soft plastic iridescent illumination includes miniature bulbs in axial array and wrapped by a transparent material, and a core line outside a connecting wire, made of soft plastic polymer, wherein the color layer outside the core line is wound round the core line.

In still another embodiment, a soft plastic iridescent illumination includes miniature bulbs in axial array and wrapped by a transparent material, and a core line outside a connecting wire made of soft plastic polymer, wherein a color layer outside the core line is provided with adhesive on a surface that contacts core line.

In yet another alternative, a plastic iridescent illumination includes miniature bulbs in axial array and wrapped by a transparent material, and a core line outside a connecting wire made of soft plastic polymer, wherein a color layer outside the core line is a sleeve that is made of thermoplastic that cases the core line.

In another embodiment, soft plastic illuminations includes miniature bulbs in axial array and wrapped by a transparent outer ecderon, a connecting wire in a side of the miniature bulbs and an inner core line made of soft plastic polymer that wraps the miniature bulbs and the connecting wire, and the outer ecderon is made of soft plastic polymer, which is a smooth line that wraps the inner core line, wherein a color layer is between the inner core line and outer cover.

The adoption of this structure will provide advantage of simple structure, aesthetic appearance, excellent decorative effect, rich and brilliant colors, wide range of applications, etc.

### BRIEF DESCRIPTION OF DRAWINGS

FIG. 1 is a structural schematic diagram according to one embodiment of the present invention.

FIG. 2 is a cross sectional view of FIG. 1.

FIG. 3 is a schematic diagram according to one embodiment of the present invention.

FIG. 4 is a schematic diagram of another embodiment of the present invention.

FIG. 5 is a schematic diagram of an additional embodiment of the present invention.

FIG. 6 is a partial schematic diagram according to an embodiment showing a color layer.

### DETAILED DESCRIPTION OF PREFERRED EMBODIMENTS

The present invention is described in details below referring to the attached drawings of the structure and preferred embodiments thereof. It includes core line 1, color layer 2, connecting wire 3, soft polymer 4, miniature bulb 5, and outer ecderon 6.

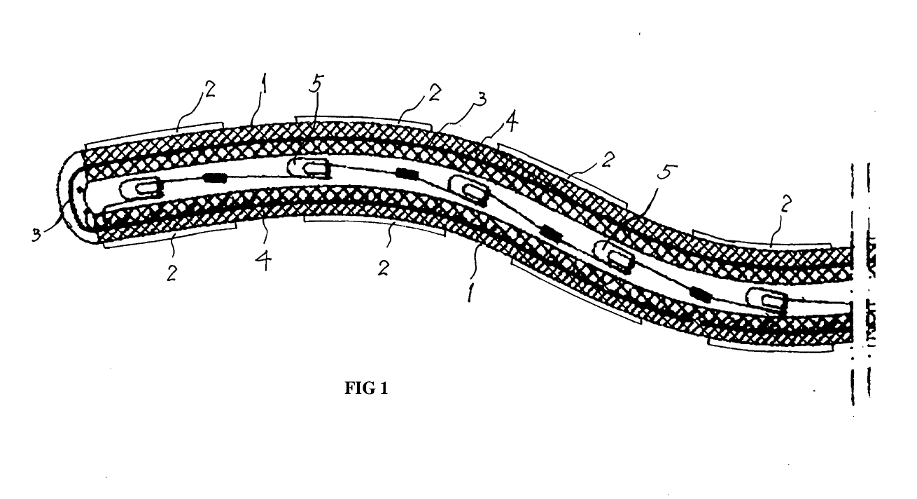

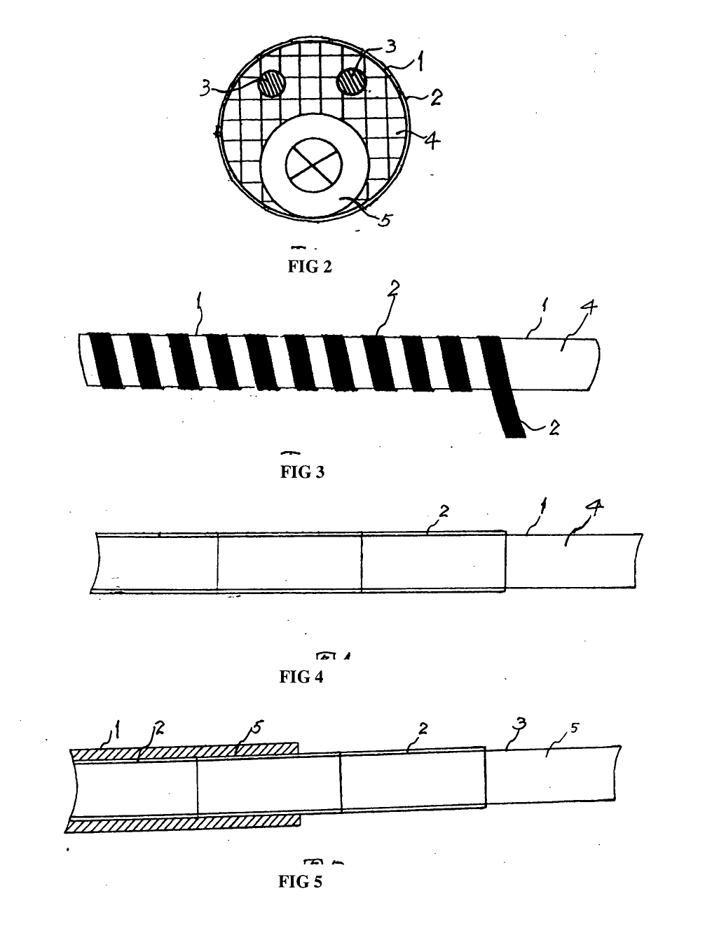

As shown in FIG. 1 to 3, a soft plastic iridescent illumination includes miniature bulbs 5 that are in axial array and wrapped by a transparent material, and a core line 1 outside the connecting wire 3 made of soft plastic polymer 4. A color layer 2 is provided outside the core line 1. In usage, miniature bulbs 5 and connecting wire 3 and others are wrapped by core line 1. Color layer 2 is wound round the core line 1 through a machine, which are pressed out integrally.

The miniature bulbs 5 and connecting wire 3 and others are wrapped by core line 1. Color layers 2 with two colors are wound abreast round the core line 1 through a machine, which are pressed out integrally. Because the core line 1 is transparent, consequently, after color layers 2 with two colors are wound round it, a three-color set is formed, and the whole soft plastic iridescent illumination presents excellent effect with very beautiful appearance.

The miniature bulbs 5 and connecting wire 3 and others are wrapped by core line 1. Outside core line 1, color lay 2 that is a sleeve made of thermoplastic cases the core line 1 (refer to FIG. 4). The color layer 2 can have single color, two colors, or multiple colors.

As shown in FIG. 5, this kind of soft plastic illuminations includes miniature bulb 6 that is in axial array and wrapped by transparent outer ecderon 1, connecting wire 4 in the side of the miniature bulbs 6 and inner core line 3 made of soft plastic polymer 5 that wraps the miniature bulb 6 and connecting wire 4, and outer ecderon 1 of soft plastic polymer, which is a smooth line that wraps the inner core wire 3. In addition, there is a color layer 2 between the inner core line 3 and outer ecderon 1. In usage, miniature bulbs 6 and connecting wire 4 and others are wrapped by inner core line 3. Color layer 2, which is made of thermoplastic sleeve, cases the inner core line 3, which is then covered by outer ecderon 1.

In this way, color layer 2 with two colors cases the inner core line 3, which is then covered by outer ecderon 1. Because the inner core line 3 is transparent, consequently, after it is cased by color layer 2 with two colors, a three-color set is formed, and the whole soft plastic illumination presents excellent effect with very beautiful appearance.

When color layer 2 with 3 colors cases directly the inner core line 3, which is then covered by outer ecderon 1, it will form soft plastic illuminations with a variety of colors.

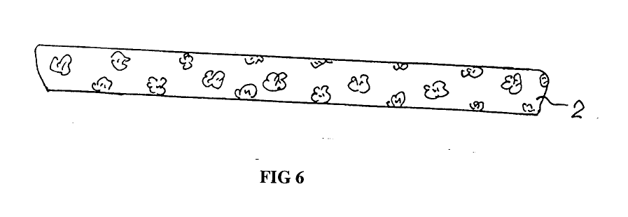

As shown in FIG. 6, color layer 2 can be printed with different kinds of patterns (such as flowers and plants, animals, cartoon figures, scenery pictures, tools, etc), the soft plastic iridescent illuminations made in this way can provide even better effects.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the present invention.

1. A soft plastic iridescent illumination includes miniature bulbs in axial array and wrapped by a transparent material, and a core line outside a connecting wire made of soft plastic polymer, wherein a color layer is provided outside the core line.

2. A soft plastic iridescent illumination includes a miniature bulb in axial array and wrapped by transparent outer ecderon, a connecting wire in a side of the miniature bulb and an inner core line made of soft plastic polymer that wraps the miniature bulb and connecting wire, and the outer ecderon is made of soft plastic polymer comprising a smooth line that wraps the inner core wire, wherein a color layer is provided between the inner core line and outer cover.

3. The soft plastic iridescent illumination as described in claim 1 wherein the color layer is wound round the core line, and the color layer is provided with adhesive on the surface that contacts with core line.

4. The soft plastic illumination as described in claim 2 wherein the color layer is a sleeve that is made of thermoplastic that cases the core line.

5. The soft plastic iridescent illumination as described in claim 1 wherein the color layer can be printed with a pattern.

6. The soft plastic iridescent illumination as described in claim 5 wherein the pattern on the color layer includes patterns of flowers and plants.

7. The soft plastic iridescent illumination as described in claim 5 wherein the pattern on the color layer includes shapes of animals.

8. The soft plastic iridescent illumination as described in claim 5 wherein the pattern on the color layer includes figures of a cartoon.

9. The soft plastic iridescent illumination as described in claim 5 wherein the pattern on the color layer includes scenery pictures or patterns of tools.

10. The soft plastic illumination as described in claim 1 wherein the color layer includes at least two different colors that are wound abreast round the core wire.
